(19) United States
(12) Patent Application Publication
(10) Pub. No.: US 2017/0251638 A1
(43) Pub. Date: Sep. 7, 2017

(54) INSULATED WEANING MAT

(71) Applicant: Jeffrey Paul Staloch, Wells, MN (US)

(72) Inventor: Jeffrey Paul Staloch, Wells, MN (US)

(73) Assignee: QC Supply, LLC, Schuyler, NE (US)

(21) Appl. No.: 15/419,073

(22) Filed: Jan. 30, 2017

Related U.S. Application Data
(60) Provisional application No. 62/304,526, filed on Mar. 7, 2016.

(51) Int. Cl. A01K 19/00; A01K 1/035; A01K 5/01; B32B 27/06; B32B 5/18; B32B 27/32; B32B 27/08; A01K 1/015; B32B 27/30

(52) U.S. Cl. CPC A01K 19/00; A01K 1/0157; A01K 1/0353; A01K 5/0107; B32B 27/302; B32B 5/18; B32B 27/32; B32B 27/08; B32B 27/065; B32B 2305/022; B32B 2471/04

(57) ABSTRACT

A weaning mat for young animals is provided that includes a top surface, a bottom surface and an insulating layer in between in which the top surface may include a rim around an edge of the top surface and ridges to compartmentalize the top surface.

### RELATED APPLICATION DATA

This application claims the benefit of Provisional Application for Patent Ser. No. 62/304,526 filed on Mar. 7, 2016.

### FIELD OF THE INVENTION

The present invention generally relates to weaning mats. In particular, the present invention is directed to an insulated weaning mat for young animals.

### BACKGROUND

In the swine industry, young pigs (or piglets) are brought into a conventional nursery or Wean-To-Finish Barn (these are two different ways to start pigs), which includes a slotted concrete floor with deep pits beneath so that fecal materials do not accumulate on the floor. Rubber mats or polyethylene sheets are commonly placed on top of the slotted concrete floor for approximately three weeks until piglets have grown sufficiently so as not to require additional heat to flourish. Some prior art rubber mats may have insulating properties but rubber mats are difficult to clean and disinfect. In addition, polyethylene sheets do not include insulation and so do not sufficiently help keep piglets warm. Further, mats with electrical heating elements do help piglets stay warm, but add expense, can be dangerous, can be more difficult to clean and can heat unevenly and/or overheat piglets.

What is needed is a weaning mat that is easy to clean and helps piglets stay sufficiently warm without the drawbacks of mats with active heating systems.

### SUMMARY OF THE DISCLOSURE

A mat for young animals is disclosed that includes a non-squishy polyethylene top surface with an outer edge and raised ribs dividing the top surface into compartments and a raised rim along the outer edge, a polyethylene bottom surface, and a non-squishy layer of closed-cell extruded polystyrene foam insulation disposed between the top surface and the bottom surface wherein the mat does not include a heating mechanism.

In another embodiment of the present invention, a portable weaning mat for piglets is disclosed that does not include a heating mechanism and has a plastic top surface, a plastic bottom surface and a layer of insulation between the top surface and the bottom surface that conveys a sufficient R-value such that piglets on the mat can stay sufficiently warm using only body heat in conditions that would require an external source of heat for piglets in the absence of the mat.

In another embodiment, a mat for young animals is disclosed that includes a rigid polyethylene top surface with an outer edge and raised ribs dividing the top surface into compartments and a raised rim along the outer edge, a polyethylene bottom surface, and a half inch layer of closed-cell extruded polystyrene foam insulation disposed between the top surface and the bottom surface.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a perspective view of an exemplary embodiment of the present invention;

FIG. 2 is another view of the embodiment of FIG. 1;

FIG. 3 is an exploded view of an embodiment of the present invention; and

FIG. 4 depicts an embodiment of the present invention in an exemplary use.

### DESCRIPTION OF THE DISCLOSURE

Weaning mats of the present invention help keep piglets or other young animals warmer than conventional mats without the need or use of an electric heating element or other heat source for the mat. The surface materials are easy to clean and disinfect and the mats are portable. In addition, the mats may include a rim around the edges to help prevent the piglets or other young animals from sliding off and raised ribs create compartments for food crumbles.

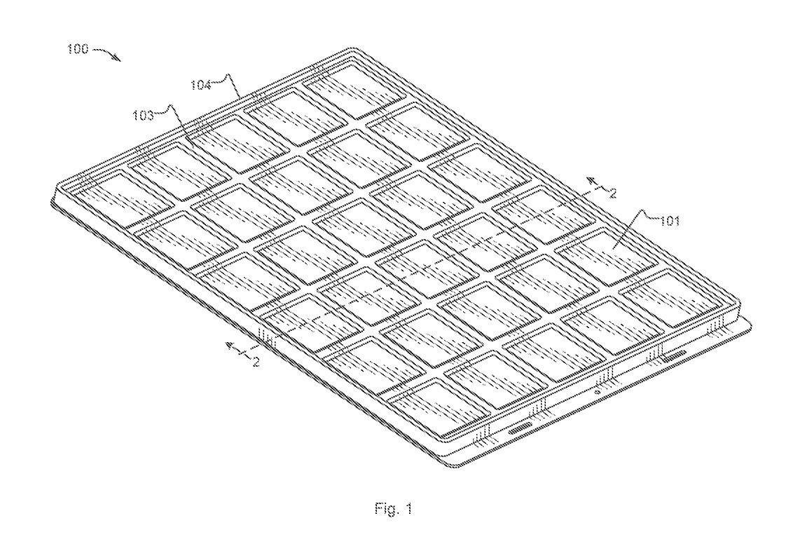

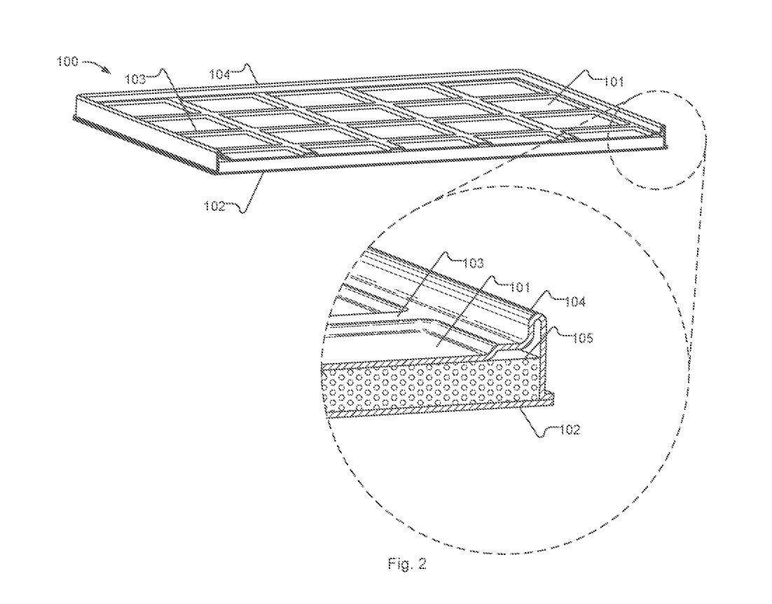

Referring to FIG. 1, a weaning or warming mat 100 of the present invention is shown. Warming mat 100 may be made of sheets of plastic. Any suitable plastic can be used. In a preferred embodiment, a high density polyethylene, high molecular weight polyethylene, or other polyethylene is used for the sheets of plastic that form a top surface 101 and a bottom surface 102 (as seen in FIG. 2), which are easy to clean and disinfect. Top surface 101 may include raised ribs 103 that can form a grid and create compartments on mat 100, which can be useful for containing and locating food crumbles, for example. Alternatively, the ribs could form circles to serve similar purposes.

Warming mat 100 may also include a rim 104 along an outer edge of top surface 101 that can help keep young animals and food crumbles on the mat. Rim 104 may have any desired height depending on the particular use of the mat. For piglets, a rim height of from about ¼ inch to about three inches, for example, may be preferable.

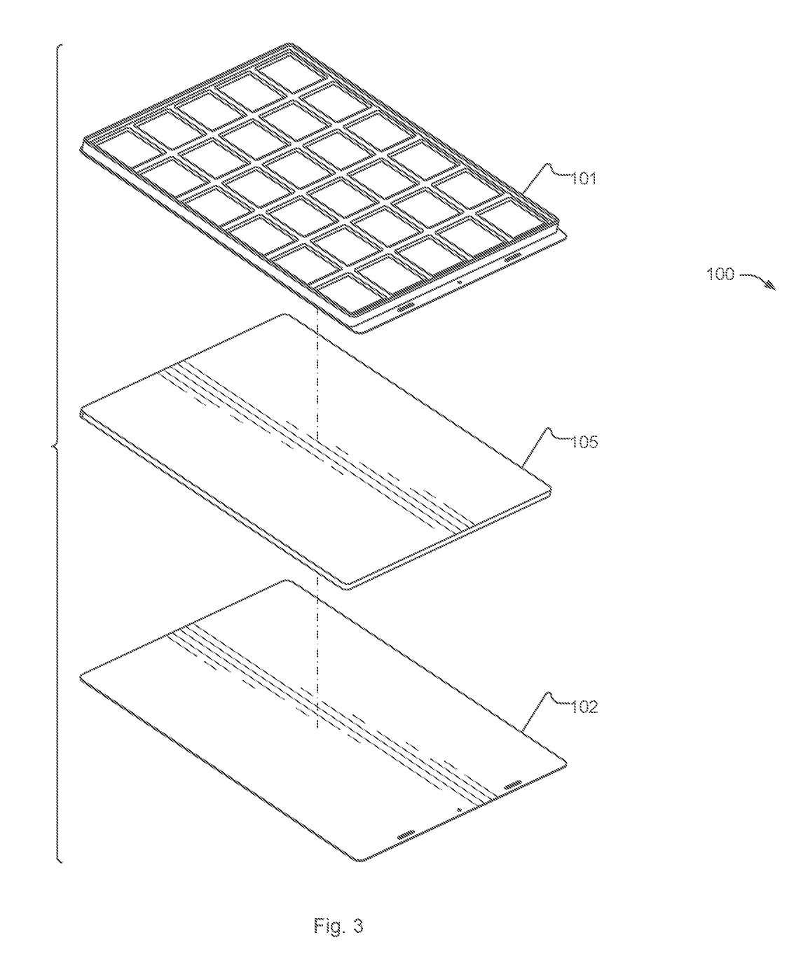

Bottom surface 102 may be joined to top surface 101 by welding the sheets together or any other suitable method. A thermal insulation layer 105 is included between top surface 101 and bottom surface 102, as shown in FIGS. 2 and 3. The insulation layer 105 can be sealed between top surface 101 and bottom surface 102 and can be made of any suitable insulation, including for example closed-cell extruded polystyrene foam.

Insulation layer 105 may be of varying thickness depending on the type of insulation and the intended use of warming mat 100. In one embodiment, the insulation layer may be approximately ½ inch to three inches thick, but may also be ¼ inch or less or ¾ inches or more depending on the intended purpose. Insulation layer 105 helps warming mat 100 reduce the rate of heat loss from the mat to the floor or other surroundings. In this manner, body heat from an animal, such as a piglet, on the mat will be lost to the environment at a slower rate and thus helps keep the animal warm. In a preferred embodiment, warming mat 100 will have an R-value between bottom surface 102 and top surface 101 of from about 1 to about 5. This can lower energy costs associated with heating animal housing and/or conventional mats. Preferably, a relatively rigid, non-squishy top surface 101 and relatively rigid, non-squishy insulation layer 105 help maintain the insulating properties of the mat by helping to resist any compression of insulation layer 105 when animals are on the mat and also can make the mat easier to clean and disinfect.

Weaning mat 100 may further optionally include handles on an end to allow for ease of lifting and moving. Handles, or other holes or loops, placed near an edge also allow the mat to be hung up for cleaning or storage.

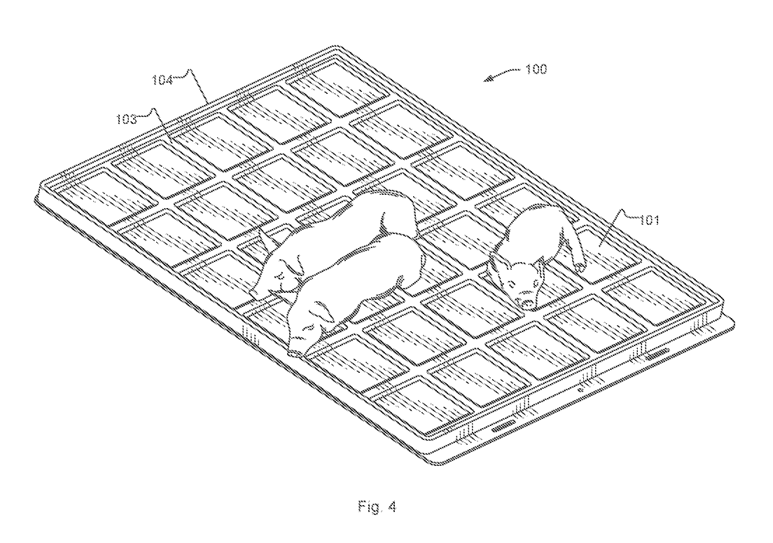

In addition to piglets (depicted in FIG. 4), warming mat 100 of the present invention may be used for other young animals, such as puppies or kittens in either commercial or residential settings.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A mat for young animals comprising:
a non-squishy polyethylene top surface having an outer edge, raised ribs dividing the top surface into compartments, and a raised rim along the outer edge;
a polyethylene bottom surface; and
a non-squishy layer of closed-cell extruded polystyrene foam insulation disposed between the top surface and the bottom surface wherein the mat does not include a heating mechanism.

2. The mat of claim 1 wherein the layer of insulation is between about ¼ inch and ¾ inches thick.

3. The mat of claim 1 further including handles on the outer edge.

4. The mat of claim 1 wherein the top surface is made of high molecular weight polyethylene.

3. A portable weaning mat for piglets that does not include a heating mechanism comprising:
a high molecular weight polyethylene top surface;
a plastic bottom surface; and
a layer of insulation between the top surface and the bottom surface that conveys a sufficient R-value such that piglets on the mat can stay sufficiently warm using only body heat in conditions that would require an external source of heat to keep piglets warm enough in the absence of the mat.

4. A mat for young animals consisting of:
a polyethylene top surface having an outer edge, raised ribs dividing the top surface into compartments, and a raised rim along the outer edge;
a polyethylene bottom surface;
a handle on the outer edge; and
a layer of closed-cell extruded polystyrene foam insulation disposed between the top surface and the bottom surface, wherein the layer is approximately ½ inch in thickness.
